(19) United States
(12) Patent Application Publication
(10) Pub. No.: US 2011/0225712 A1
(43) Pub. Date: Sep. 22, 2011

(54) BARRIER SUIT

(76) Inventors: Stephen Anthony Rawlings, Shropshire (GB); Thomas Douglas Rawlings, Shropshire (GB)

(21) Appl. No.: 13/132,329

(22) PCT Filed: Dec. 2, 2009
(86) PCT No.: PCT/GB2009/051630

§ 371 Date: Jun. 2, 2011

(30) Foreign Application Priority Data
Dec. 3, 2008 (GB) 0822028.7

(51) Int. Cl. A62B 17/00

(52) U.S. Cl. 2/457

(57) ABSTRACT

A barrier suit (10) comprises a one-piece suit for fully encapsulating a user. The suit has a main body portion (12) for fully encapsulating a user's torso, arms, hands, legs and feet and a hood (21) integral with the main body portion for positioning over and encapsulating the user's head. The hood (21) includes an integral filter respirator (46) through which external air can be drawn into the suit for breathing. The suit is made from materials which are non-permeable to particulates and vaporous gases and the seams are sealed. The filter respirator may have a moulded body (48, FIG. 6) for positioning over a user's nose and mouth, the body have sealing portions (49, FIG. 6) for sealing engagement with the user's face. The suit can be provided in one-size to fit a large proportion of the population and has various belts and straps that can be adjusted to provide a satisfactory fit for an individual user.

The present invention relates to a protective barrier suit and in particular to a fully encapsulating barrier suit, made up into one integral part.

It is known to provide encapsulating protection ensembles made up of various separate components to protect wearers from harmful airborne contamination, for example from nuclear debris radioactive fallout, bacteriological and viral airborne contamination and airborne chemical agents. These ensembles typically comprise a suit made of an impermeable but flexible material which encapsulates the wearer's torso, legs and arms and at times head. Other components such as boots, gloves, headgear, helmets, and respirators are added to offer complete encapsulation. The known fully encapsulating ensembles are also usually provided with a separate air supplied respirator or an air filtering respirator. The respirator may be internally or externally fitted. The known encapsulating protection ensembles are of a high specification with several component parts and are intended for use by specialist military, emergency and industrial personnel acting in close proximity to the source of potential contamination.

The known encapsulating protection ensembles are effective at protecting the wearer from airborne contamination but are expensive to produce and are unsuitable for use by the general population. They can be cumbersome, and heavy, take a long time to don, contain several separate component parts and require specialist user knowledge.

Protection ensembles which do not fully encapsulate the wearer are also known. These can be used together with a respirator to filter out airborne contaminants to provide a more limited protection. CBRN (Chemical, Biological, Radiological, and Nuclear) suits are examples of this type of arrangement. Non-encapsulating ensembles of this nature usually comprise of a separate jacket and separate trousers but may be in the form of an overall having a hood and are designed to be fitted over existing clothing and used with separate boots and gloves. These types of ensembles can be made of a variety of materials including impermeable materials such as a rubber coated canvas, polymers bonded to woven fabrics or sheet polymers

The known non-encapsulating protection ensembles are less effective than fully encapsulating ensembles at protecting the wearer from airborne contaminants, which can find their way into contact with the wearer's skin through gaps between the various component parts. Whilst not as expensive as fully encapsulating ensembles, the known non-encapsulating ensembles are still relatively expensive to produce making it prohibitive to equip large numbers of the general population with protection of this nature.

It is also a drawback of the known arrangements that full protection requires a number of separate components: the suit or a jacket and trousers, a respirator, separate gloves, and separate boots. All of these components must be appropriately sized to fit the individual wearer and, at least in the case of the respirator, require specific training to use effectively. This adds to the cost of equipping an individual and makes storage and distribution to large numbers of people difficult.

There is a need then for an alternative form of a complete encapsulating barrier suit which overcomes, or at least mitigates, some or all of the drawbacks of the prior art.

In accordance with the invention, there is provided a complete barrier suit comprising one-piece suit for fully encapsulating a user, the suit having a main body portion for fully encapsulating a user's torso, arms, hands, legs and feet and a hood integral with the main body portion for positioning over and encapsulating user's head, the hood including an integral filter respirator through which external air can be drawn into the suit for breathing.

With the exception of any filter panels, the suit may be made from materials which are non-permeable to particulates and vaporous gases.

The hood may be transparent or it may comprise an integral transparent visor portion.

The main body portion may comprise arm portions with integral hand enclosing portions and leg portions with integral foot enclosing portions.

The filter respirator may comprise a moulded body for positioning over a user's nose and mouth, the body have sealing portions for sealing engagement with the user's face. The respirator may comprise an integrated strap arrangement, the strap arrangement being adjustable to secure the respirator over a user's mouth and nose. The respirator may have an exhalation outlet valve through which exhaled air may be expelled. The exhalation valve may have an inlet fluid passage arrangement through which fluid can be administered to a user from an external source and a closure arrangement for selectively opening and closing the inlet fluid passage arrangement.

The suit may comprise an adjustable integral waist strap arrangement or belt made from a flexible material.

The main body portion of the suit may incorporate one or more filter panels through which air can be admitted into or expelled from the suit. At least one filter panel may be located in a lower back region of the main body portion. In addition or alternatively, at least one filter panel may be provided in each foot enclosing portion. At least one filter panel may be provided in a side wall region of each foot enclosing portion and in one embodiment a filter panel is provided on each side of each foot enclosing portion.

An external surface of the sole region of each foot enclosing portion may be coated with anti-slip material and/or provided with anti-slip formations.

A sole region of each foot enclosing portion may be reinforced with additional material to resist puncture.

Each foot enclosing portion may be provided with an inner sole member. The inner sole may be made of a relatively soft material to provide comfort and to seal any punctures that may be produced in the sole when the suit is in use.

Each foot enclosing portion may be provided with an integral adjustable mechanism to maintain a secure and comfortable fit to the wearer. The adjustable mechanism may comprise one or more adjustable straps.

The filter respirator may have a filter panel comprising activated carbon woven fibers laminated onto a fine particulate filter felt.

The, or each, filter panel in the main body portion may comprise activated carbon woven fibers laminated onto a fine particulate filter felt.

The main fabric of the suit may comprise a non-woven and non-breathable barrier laminated to a woven fabric. In which case, the non-breathable barrier may be selected from any one or more of the following: Polyurethane (PU), Polyvinyl Chloride (PVC), Polyethylene (PE), Ethylene Vinyl Acetate (EVA), or the like and the woven fabric may be selected from any one or more of the following: Polyester derivates including Polyester Cotton (PC), Nylon and its derivatives, cotton, rayon, and linen or the like.

Alternatively, the main fabric of the suit may consist only of a non-woven, non-breathable barrier material such as PVC, PU, PE, EVA, or the like.

Any seams may be sealed and non-permeable. The seals may be formed for example by ultrasonic welding or tape welded.

The suit may have an entry opening which is closed by means of an air tight sliding fastener.

In one embodiment, the sliding fastener comprises a first continuously extruded elongated strip attached to the suit fabric along one side of the opening, a second continuously extruded elongate strip attached to the suit fabric along the other side of the opening, the first strip having a male projection and the second strip having a corresponding groove to receive the projection to form an air tight seal, the fastener having a slider which can be moved longitudinally of the fastener in one direction to force the male projection into the groove to close the fastener and in the opposite direction to separate the male projection from the groove to open the fastener.

A seal member may be provided internally of the first and second strips at an end of the fastener at which the slider is positioned when the fastener is fully closed, the seal member being configured to seal any gaps remaining between the first and second strips and the slider.

A curtain of activated carbon material may be positioned at each end of the fastener to prevent, or at least resist, the ingress of contamination should the wearer inadvertently not close up the fastener completely.

The barrier suit may be dimensioned so that it can be worn by a majority of the able bodied, adult population. In particular, the barrier suit may be dimensioned so that it can be worn by up to 80%, more preferably 90%, and most preferably up to 98%, of the able bodied, adult population.

The barrier suit may be supplied in a vacuum packed bag to extend the suit's shelf life.

An embodiment of the invention will now be described, by way of example only, with reference to the accompanying drawings, in which:

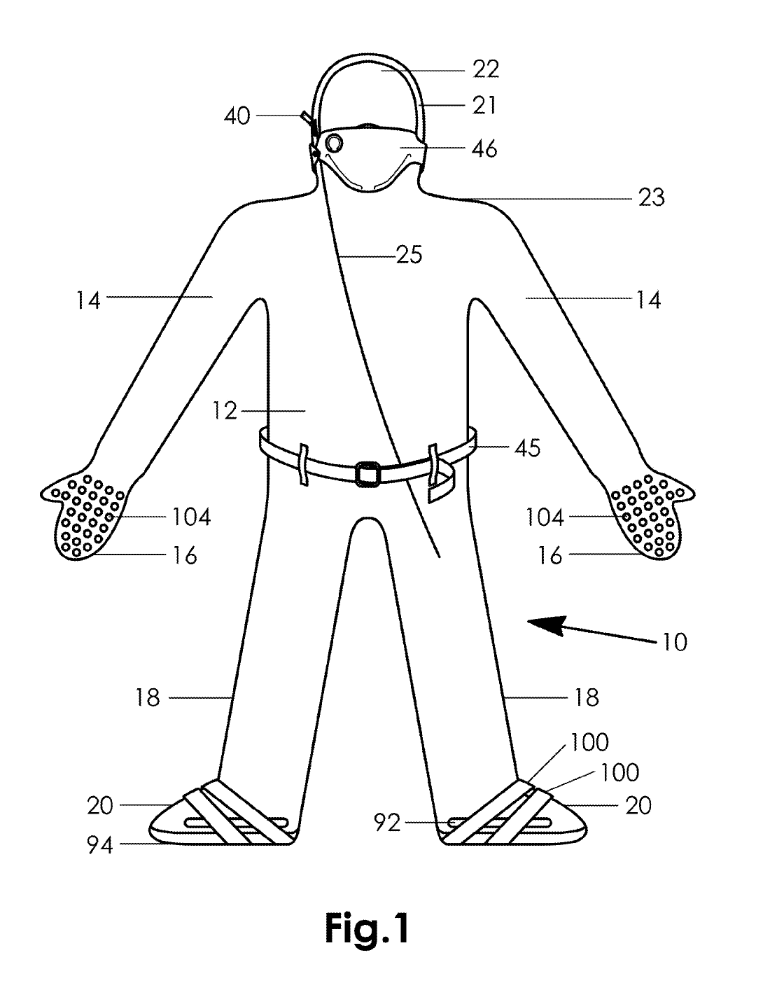

FIG. 1 is a front view of a barrier suit in accordance with the invention;

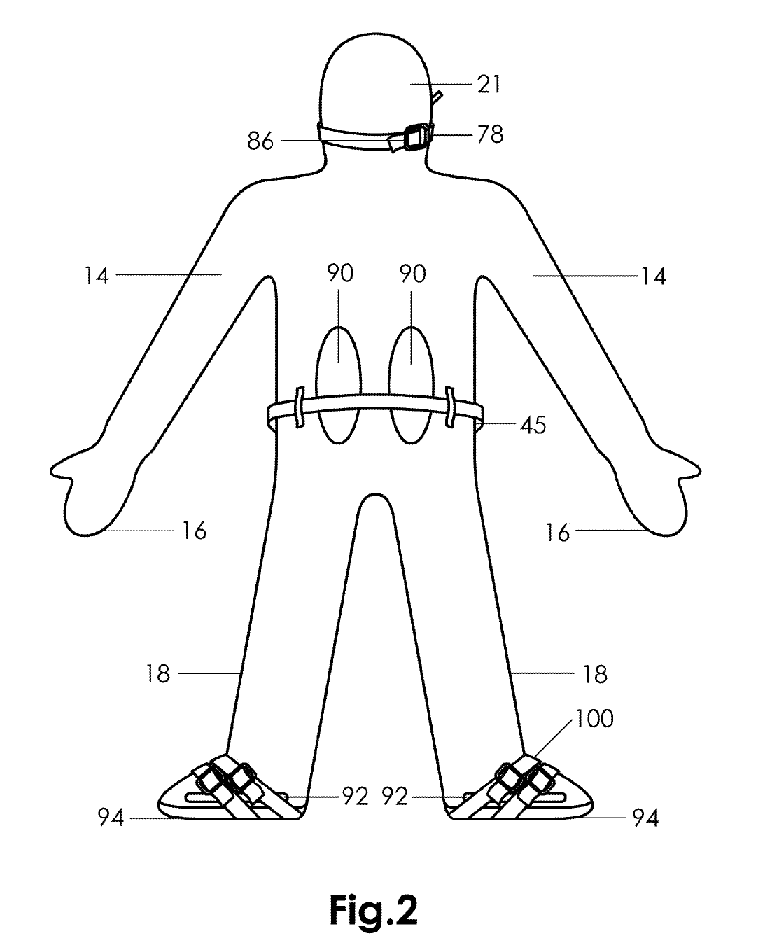

FIG. 2 is a rear view of the suit of FIG. 1;

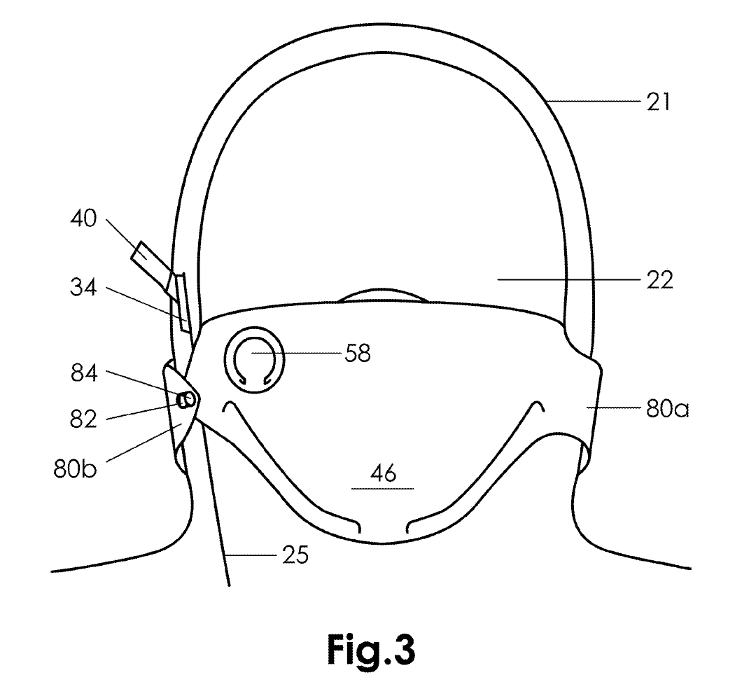

FIG. 3 is a view on an enlarged scale of a hood portion of the suit of FIG. 1 from the front;

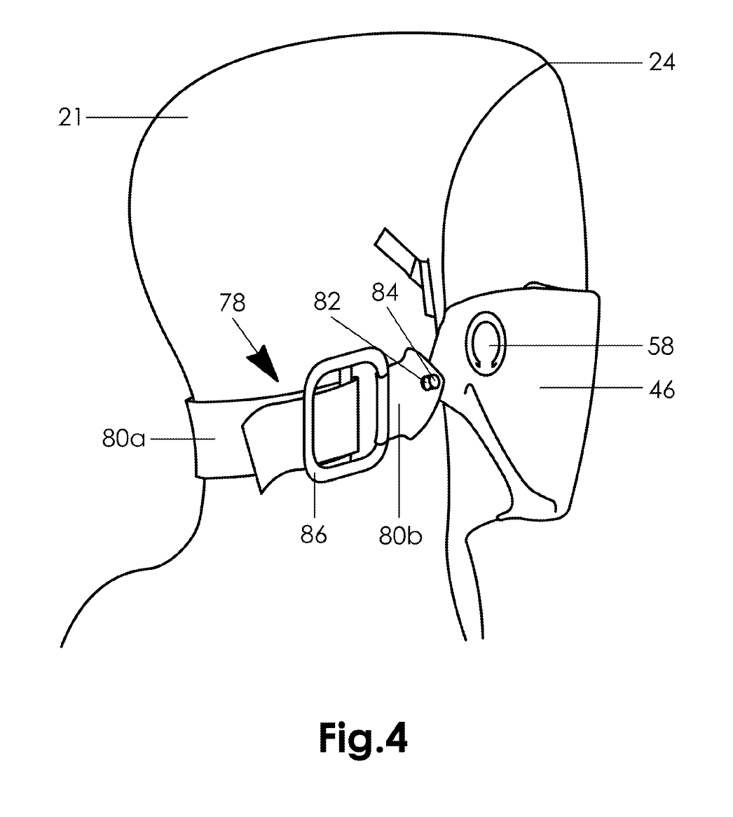

FIG. 4 is a view on an enlarged scale of a hood portion of the suit of FIG. 1 from one side.

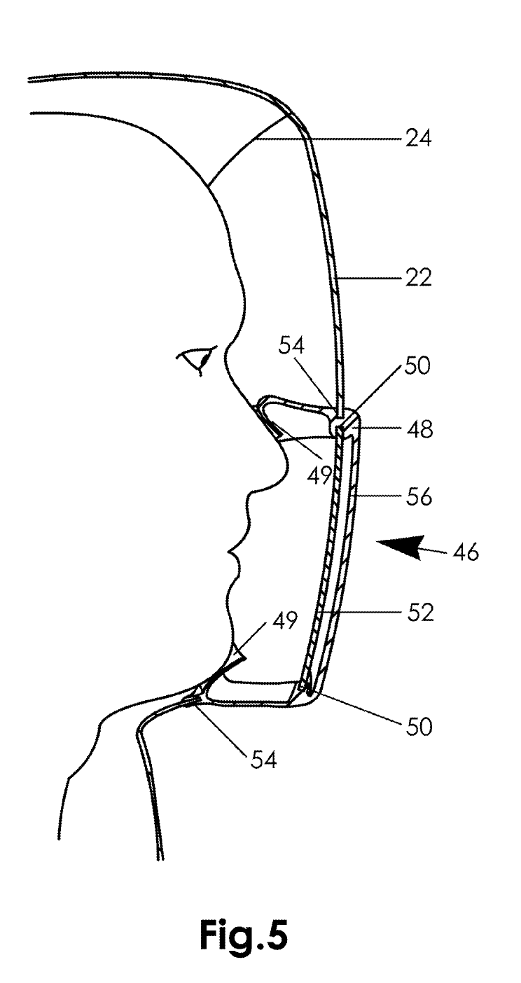

FIG. 5 is a longitudinal cross sectional view through the hood portion of FIG. 4, showing a respirator forming an integral part of the hood in position on a users face;

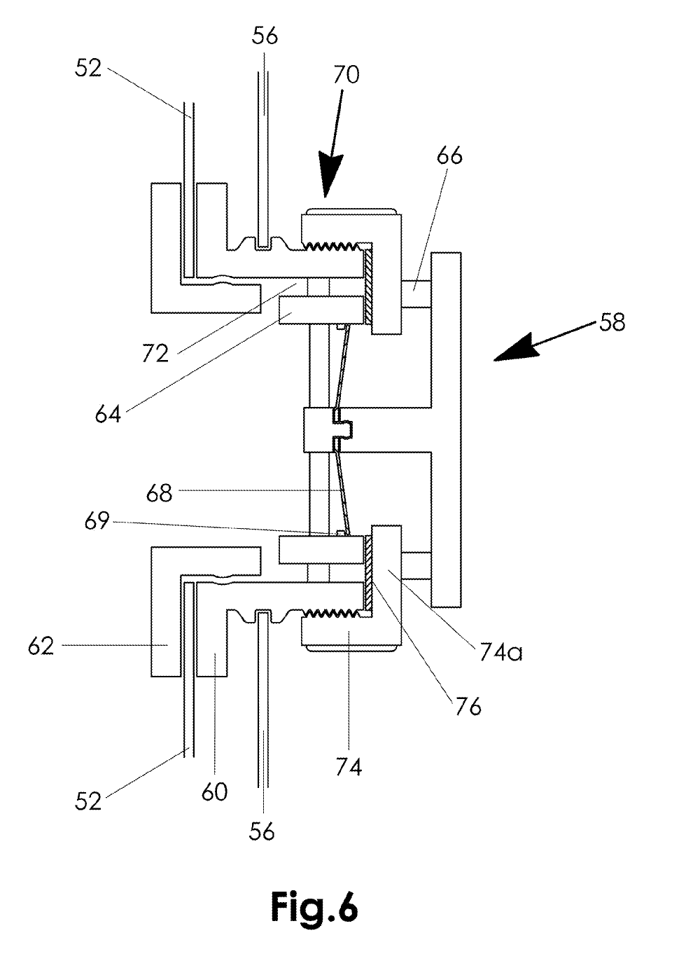

FIG. 6 is a cross-sectional view through an exhalation valve forming part of the respirator in FIG. 5;

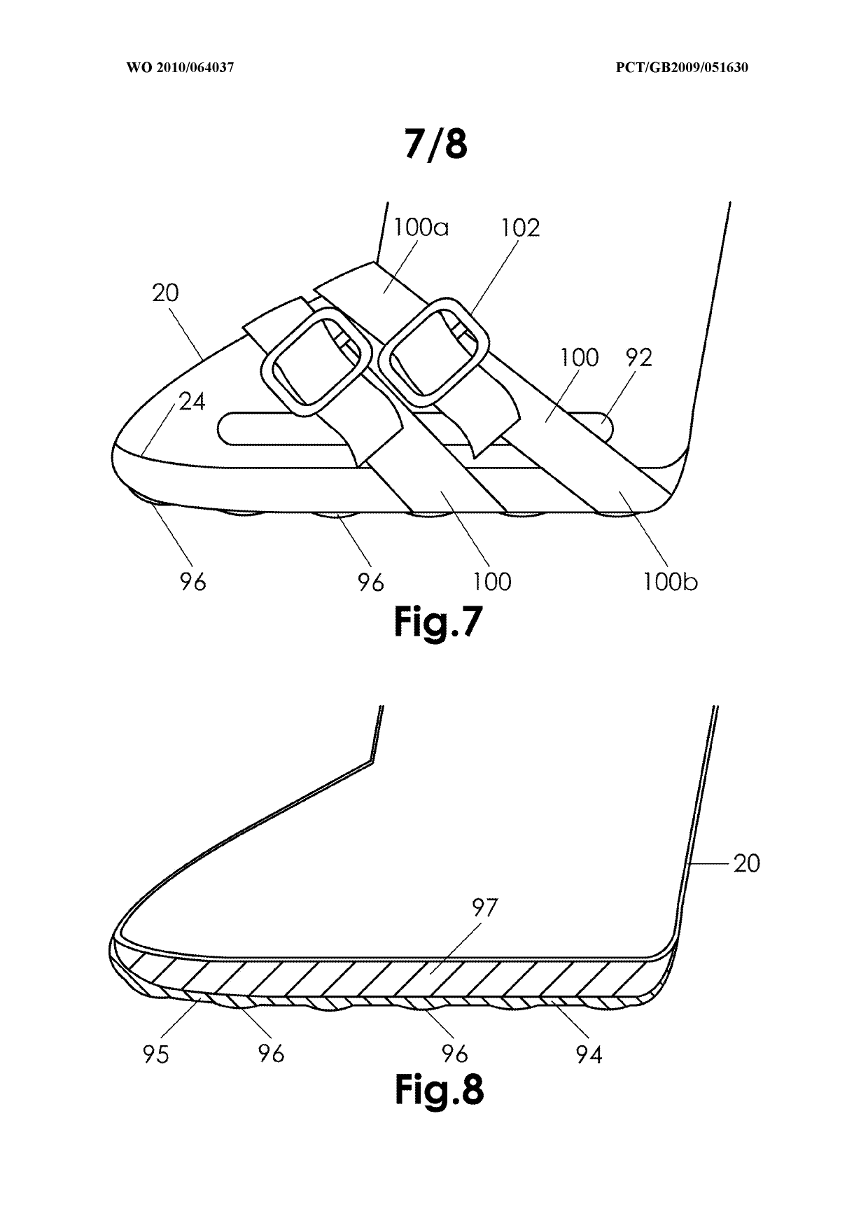

FIG. 7 is side view on an enlarged scale of a foot enclosing portion of the suit of FIG. 1.

FIG. 8 is a cross sectional view through the foot section of FIG. 7;

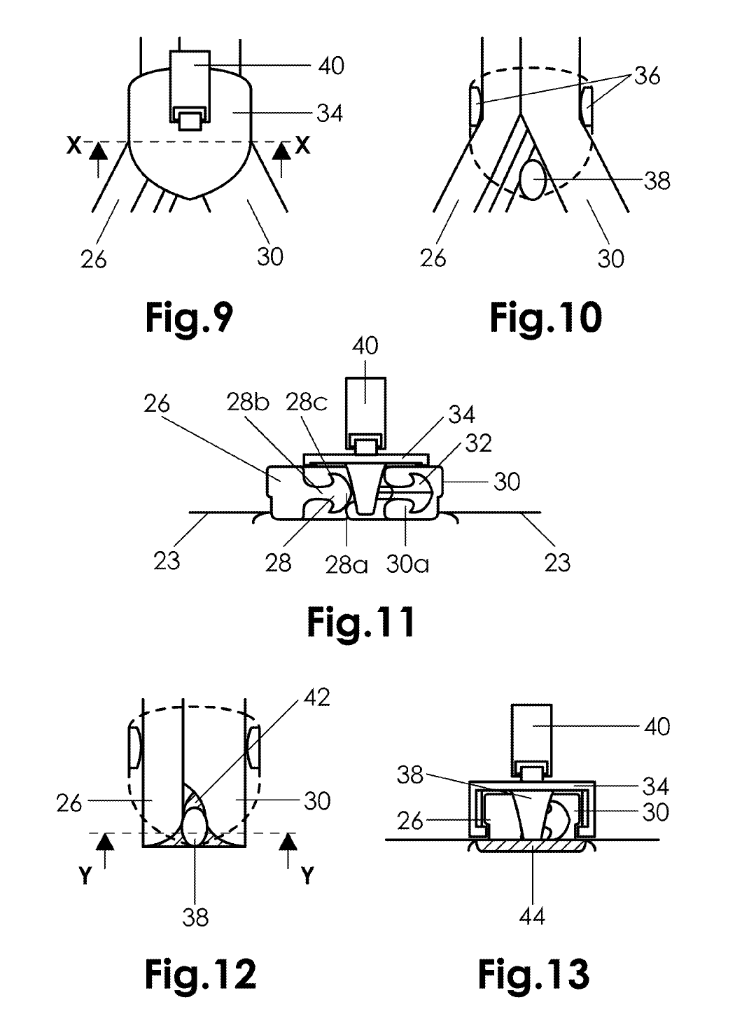

FIG. 9 is a plan view of part of a fastener for using in the barrier suit of FIG. 1;

FIG. 10 is a view similar to that of FIG. 9 but with an upper part of a slider shown in outline only;

FIG. 11 is a cross sectional view through the fastener of FIG. 9 taken on line X-X in FIG. 9;

FIG. 12 is a plan view of an end region of the fastener of FIGS. 9 to 11 showing a slider in a closed position and in which an upper part of the slider is shown in outline only; and

FIG. 13 is a cross sectional view through the end region of the fastener, taken on line Y-Y in FIG. 12.

A fully encapsulating barrier suit in accordance with the invention is indicated generally at 10.

The barrier suit 10 is intended primarily for use in situations in which the wearer is not in direct contact with a source of intense contamination but will be in contact with diffused airborne contamination which still poses a valid threat to life or health over a short period of time if no form of protection was worn. Typically, such situations would include evacuation of the general population where protection against airborne contamination from industrial accidents, nuclear debris, radioactive fallout, biological airborne contamination, airborne chemical agents and the like is required. However, the barrier suit 10 can also be used in a professional capacity where operators need to be completely enclosed to protect them from relatively low level contamination and/or so that the wearer of the suit will not contaminate their working environment. This could include use by forensic investigators at a scene of a crime to prevent bodily contaminants passing from the wearer to the scene of crime or use by operatives whilst working within a sterile clean room environment, for example.

The suit 10 is a one-piece, fully encapsulating barrier suit having a main body portion 12 for fully encapsulating a user's torso, arms, hands, legs and feet. The main body portion includes arm portions 14 with integral hand enclosing portions 16 and leg portions 18 with integral foot enclosing portions 20. The suit also includes an integral hood portion 21 which fully encapsulates a wearer's head and neck region. The hood portion 21 may be made of a transparent material or it may incorporate an integrated see-through visor panel 22.

The suit 10, including the visor panel, is constructed of materials which provide a non-permeable barrier for particulates and vaporous gases. Various materials can be used. The main fabric 23 of the suit may include a non-woven and non-breathable barrier layer laminated to a woven fabric. The non-woven barrier layer could be made of any suitable material such as PU, PVC, PE, EVA, or the like. The woven fabric can be any suitable material such as: Polyester derivates including Polyester Cotton (PC), Nylon and its derivatives, cotton, rayon, and linen or the like. Alternatively the main fabric of the suit may be constructed purely of a non-woven, non-permeable barrier material such as PVC, PU, PE, EVA or the like.

To ensure the suit 10 provides an effective barrier, all the seams 24 are sealed. Depending on the nature of the material used, the seams may be produced by ultrasonic welding or the seams may be tape welded or any other method which will create a non-permeable and airtight seal. Ultrasonic welding may be appropriate if the material is a polymer fabric but welded tape seams may be more appropriate if the material used has a coating of polymer on one side only.

The main fabric 23 of the barrier suit is preferably light weight, especially when compared to the materials used in many known protection ensembles. The visor panel 22 can be made from a transparent polymer such as PVC or a similar material. The visor may also include an anti-fogging hydrophobic additive applied to the interior.

The suit has an entry opening which extends across the front of the main body portion 12 and partway up one side of the hood 21, through which a user can gain entry into the suit. The opening is closed by means of an air tight sliding fastener 25 which can be closed by the user once the suit 10 has been put on. The sliding fastener may be a zip type fastener or it may be a continuous interlocking sliding fastener made of a polymer, such as polypropylene (PP). However, any suitable air-tight fastener or closure can be used.

An example of a suitable continuous interlocking fastener 25 is shown in detail in FIGS. 9 to 13. The fastener 25 comprises a first elongate member 26 attached to the suit material 23 along one side of the opening and which has a male seal protrusion 28. A second elongate member 30 is attached to the suit material 23 along the opposite side of the opening and has a corresponding groove formation 32 for receiving the male protrusion 28. The elongate members 26, 30 are made of suitable materials that enable the male protrusion to be pressed into the groove to form an air tight seal. Thus the second elongate member 30 may be made of a material which relatively resiliently deformable whilst the first elongate member 26 is made of a more rigid material. The protrusion 28 and the groove 32 are shaped so that once the protrusion is inserted it cannot be easily pulled out of the groove by application of a lateral force, such as may be exerted by pulling on the material of the suit either side of the opening. In the present embodiment, the male protrusion 28 has a head portion 28a which is attached to the main body of the elongate member by a relatively narrow neck portion 28b. The head 28a is curved and has concave portions 28c which face the main body and which engage behind correspondingly curved portions 30a of the second elongate member 30 when the projection 28 is engaged in the groove 32.

The fastener 25 is opened and closed by means of a slider 34 that can be moved along the elongate members 26, 30 to engage and disengage the male projection 28 and the groove 32. As shown in FIG. 10, the slider comprises a pair of cams 36 which engage with the elongate members 26, 30 so that when the slider is moved in a first direction (downwardly as shown in FIG. 10) the elongate members 26, 30 are clamped together forcing the male protrusion 28 to engage in the groove 32. This closes the opening and forms an air tight seal. The slider also has a separator 38 which locates between the two elongate members 26, 30 and is configured to separate the male protrusion 28 from the groove 32 when the slider is moved in the opposite direction. A tag 40 is pivotally mounted to the slider 34 to be gripped by a user to open and close the fastener 25.

When the fastener is fully closed, the separator 38 locates in a recess 42 in an end region of the second elongate member as shown in FIGS. 12 and 13. A layer 44 of a soft polymer material is located across the inner surface of the elongate members 26, 30 in the end region to form an air tight seal between the elongate members 26, 30 and the slider 34. A curtain of activated carbon material may also be positioned at each end of the fastener 25 to prevent, or at least resist, the ingress of contamination should the wearer inadvertently not close up the fastener completely.

With the fastener 25 in an open condition, a user can put the suit on in a manner similar to that used when donning a pair of overalls. Thus the user inserts their legs through the opening into the leg portions 18, puts their arms into the arm portions 14 and puts the hood portion 21 in position over their head. The user then closes the fastener 25 to isolate themselves from the surrounding environment. The suit also comprises a belt 45 that can be adjusted to fit the individual wearer to make the suit more comfortable and practical to wear. The belt can be made of any suitable materials including any of the materials used to form the main fabric 23 of the suit as discussed above. The belt can be fastened in any suitable manner including tying, use of a hook and loop fabric system or use of a mechanical fastener such as buckle as shown. The belt is integrally attached to the suit by means of loops but other means of attaching the belt to the suit can be used.

Unlike known encapsulating protection suits, the barrier suit 10 in accordance with the invention does not incorporate artificial breathing apparatus. Instead, the hood portion 21 incorporates an integral respirator 46 having a filter through which external air can be drawn to enable a wearer to breath. As illustrate more particularly in FIG. 5, the respirator in the present embodiment includes a body 48 having face sealing portions 49 which engage with the wearer's face about their nose and mouth.

As illustrated in FIG. 5, the respirator body 48 has an internal groove 50 for mounting a filter panel 52. The body 48 also includes means for integrally attaching the respirator to the suit such as en external groove or slot 54. The respirator can be constructed separately from the rest of the suit and attached to the suit by means of heat or ultrasonic welding or any other method which will create a non-permeable and airtight seal. The respirator body 48 also has an external shield portion 56 to protect the filter panel. The shield portion 56 has suitable openings that allow air to pass through but helps to protect the filter panel 52 from large particulate atmospheric pollutants. The shield also allows water to run off the hood 21 and visor portion 22 of the suit without penetrating the filter panel 52.

The respirator 46 includes a one-way exhalation valve 58 which is located in the vicinity of the wearer's mouth. The valve 58 is useful in aiding expulsion of exhaled air which carries moisture and carbon dioxide to reduce the discomfort of the wearer. Any suitable exhalation valve can be used but one embodiment is illustrated in detail in the FIG. 6. The valve 58 is mounted about an opening in filter panel 52 in the respirator 46. The valve 58 includes a main body 60 attached at an inner end to the filter panel 52 by means of an internal clamp member 62. The main body 60 passes through an opening in the outer shield 56 of the respirator and has an external groove to receive an edge region of the shield. The main body 60 has a central passage 64 which defines a flow path leading to ports 66 through which fluid (typically exhaled gases and moisture) can pass to atmosphere. Flow through the central passage 64 is controlled by a diaphragm 68 which prevents air or other fluids from being drawn in through the central passage but which opens when a user exhales to allow the exhaled gasses and moisture to pass out. The diaphragm 68 is mounted to a central spigot on the main body portion and its outer edge is biased into engagement with a seal member 69 located on a cylindrical wall which defines the central passage 64. When exhaling quickly or deeply through coughing or sneezing, an otherwise large and sudden pressure build up can be expelled efficiently through the valve 58, without which, the pressure could be released through the face sealing points 49 of the integrated respirator 46 and fog the inside of the visor 22.

The valve 58 also includes a fluid inlet arrangement indicated generally at 70 to enable fluids, such as water or oxygen, to be administered to the wearer should this be required, say for medical purposes. The fluid inlet arrangement 70 includes a by pass passage 72 in the main body 60 through which fluids can flow between the ports 66 and the interior of the valve without being controlled of the diaphragm. The by-pass passage is located outside of the central passage 64 and is opened and closed by means of a closure member 74 in screw threaded engagement with the main body 60. The closure member 74 has a portion 74a which extends across an outer end of the by-pass passage 72 and carries a seal or gasket 76 made of a suitable sealing material. In normal use, the closure member is screwed to a closed position, as shown in FIG. 6, in which the sealing material 76 is clamped between the portion 74a and the main body 60 to close off the by-pass passage 72. With the closure member 74 in the closed position, fluid can only pass through the valve via the central passage 64 under the control of the diaphragm 68. When fluid is to be administered to a wearer, the closure member 74 is unscrewed slightly to open a flow path from the ports 66 to the by-pass passage and hence to the interior of the respirator and the wearer. An attachment can be applied to the front of the valve to feed the wearer with a given substance.

It is important that an airtight fit is achieved between the respirator 46 and the wearer's face whilst the suit is being worn to prevent the build-up of exhaled CO2 and to direct exhaled air out through the exhalation valve 58. This also prevents a build-up of humid air in the interior of the hood 21 and therefore prevents the visor interior from fogging as can occur with other known protection ensembles. For this reason, the respirator has an adjustable strap arrangement 78 to hold the respirator in close engagement with the wearer's face. The strap arrangement includes a strap having first strap portion 80a attached to or integrally formed with one side of the respirator main body 60 and a second strap portion 80b which has an opening 82 for engagement with a projection 84 on the other side of the respirator body 60. The two strap portions 80a, 80b are interconnected by means of a buckle 86 to enable the length of the strap to be adjusted so that respirator is held in close contact with the wearer's face and to provide an air tight seal with the face engaging portion 49. The strap portions 80a, 80b can be made of any suitable materials but advantageously they are made of a stretchable resilient material such as elastic rubber, Thermoplastic Elastomer or the like.

The suit will typically be supplied with the strap portions 80a, 80b pre-threaded through the buckle 86 so that a user does not have to spend time threading the strap portions before donning the suit. Once the suit has been put on, the user simply has to adjust the strap and adjust the fit of the respirator 46.

The respirator 46 and the strap arrangement 78 can be made of any suitable materials but are preferable injection moulded from one or more polymeric materials. The respirator 46 and/or strap arrangement 78 could be manufactured from several different polymeric materials using a multi-stage injection process. In this way, the main body portion 48 can be moulded from a material having suitable levels of structural rigidity, such as Polypropylene, with the flexible parts, such face engaging portions 49 and strap 80a, 80b, being over-moulded on to the main body 48 from a relatively soft polymer such as a TPE or similar.

Other means for adjustably interconnecting the strap portions 80a, 80b can be used such as a hook and loop fabric or an alternative mechanical fastener.

To make the barrier suit 10 more comfortable to wear for extended periods, filter panels 90 may be incorporated into the body portion 12 to allow filtered air to pass out of and into the suit to facilitate a greater degree of comfort. The filter panels 90 also improve the ergonomic wearability of the suit by enabling air to vent out of the suit when a wearer attempts to sit rather than just re-aligning air around the suit. Conversely, when a wearer attempts to stand, air is able to enter the suit through the panels 90 making it more comfortable and allowing the body temperature to remain stable. In the present embodiment, there are two filter panels 90 located in the lower back region of the suit. The filter panels 90 cover openings in the main suit fabric.

As can be seen from FIGS. 1, 2 and 7, further filter panels 92 are provided in the side regions of the foot enclosing portions 20 spaced upwardly from but running parallel to the sole 94. The further filter panels 92 in the foot enclosing portions 20 also act as drainage points for any body fluids that may be excreted inside the suit, such as urine.

The filter panels 52, 90, 92 can be made of any suitable material capable of filtering out the contaminants the suit is expected to protect against. However, in the present embodiment, the filter panels comprise activated carbon woven fibres laminated onto a fine particulate filter felt. The nature of this material allows moisture to pass through without the efficiency of the carbon filtration being affected. As already stated, the barrier suit 10 is a one-piece construction having integral hand and foot enclosing portions, visor and respirator which fully encapsulates or encloses the wearer so that once the fastener 25 is closed; the suit provides a closed atmosphere. Air is only able to enter the suit through the filter panel 52 in the respirator 46 and the filter panels 90, 92 that are all configured to remove expected contaminates. The interior of the barrier suit 10 is not pressurised as is often the case with known fully encapsulating protection suit ensembles and no separate air supply is provided internally.

The barrier suit 10 can be worn over conventional clothing, including business suits, and sensible shoes, e.g. not stilettos or other forms of footwear that might damage the integrity of the barrier suit. To reduce the chances of the fabric being damaged due to abrasion with the user's shoes and the ground, the sole 94 may be reinforced with additional material 95 which may be an anti-slip material and/or provided with anti-slip formations 96. The foot enclosing portions 20 may also be provided with an inner sole portion 97 made from a soft polymer such as a Thermoplastic Elastomer. The inner sole 97 not only adds comfort but may also be effective in sealing, or at least partially sealing, punctures in the outer sole 94 should they be produced when the suit is being worn.

Each foot enclosing portion 20 is provided with a mechanism to maintain a secure and comfortable fit to the wearer. In the present embodiment, this takes the form of an adjustable strap arrangement. The strap arrangement comprises a pair of straps 100, each having two strap portions 100a, 100b. Each strap portion 100a, 100b is integrally attached at one end to one side of the foot enclosing portion. The free ends of the strap portions 100a, 100b are adjustably interconnected by means of a buckle arrangement 102. This enables a wearer to tighten the straps after the suit has been put on to ensure the foot enclosing portions 20 are securely fitted. Whilst a buckle arrangement as shown is convenient, any suitable means of adjustably connecting the strap portions can be used. This could include use of a hook and loop fabric system or an alternative mechanical mechanism or in a very simple arrangement by tying the portions together.

The hand enclosing portions 16 may be in form of mittens as shown or they may be provided with separate finger portions. The hand enclosing portions may also be covered in a soft polymer such as Thermoplastic Elastomer or an anti-slip finish 104.

As discussed above, the suit 10 is made from lightweight materials, which means that it can be folded in a relatively small package. In one embodiment, the suit 10 is supplied within a vacuum packed plastic bag. This prevents contaminants from migrating to the suit during storage and extends the shelf life of the suit by a considerable period of time. This type of packaging makes storage and distribution of the suits easier and also means that each packaged barrier suit 10 is compacted to a size that is easily transportable within a handbag or briefcase for instant use.

Barrier suits 10 in accordance with the invention are more lightweight and simpler to manufacture and use than the known conventional protection ensembles. This means that the suits 10 in accordance with the invention can be produced at a fraction of the price of the conventional protection ensembles. Furthermore, because a barrier suit 10 in accordance with invention is fully encapsulating, it can be provided in one size that will fit the majority of the adult population. It is expected that a one-size barrier suit in accordance with the invention will fit up to 80%, more preferably 90%, and most preferably 98%, of the able bodied, adult population. This further reduces manufacturing and supply costs and eliminates the need for individuals to be allocated specific sized suits, as is required with the known protection ensembles. Alternatively, barrier suits 10 in accordance with the invention could be made in a very limited range of sizes, e.g. small/medium/large and child sizes. The provision of a belt 45 and adjustment straps 78, 100 on the respirator 46 and the foot enclosing portions 20 make it possible for a one-size suit to be adjusted by each wearer to suit their requirements and so that they are able to move about in relatively safety and comfort.

Being of one-piece construction with no additional components such as a separate respirator, gloves, boots or breathing apparatus, barrier suits 10 in accordance with the invention are simple to use without detailed instruction or familiarisation training, as is required with existing protection ensembles, and can be easily carried around or stored for instant use. The barrier suits 10 in accordance with the present invention can be donned very quickly (less than 2 minutes) and easily by an inexperienced wearer with no prior training or assistance. This makes barrier suits 10 in accordance with the invention particularly suitable for use by members of the general population as opposed to protection ensembles that are designed for use by military, commercial and specialist emergency personnel.

Because barrier suits 10 in accordance with the invention are fully encapsulating, they offer greater protection than the known non-encapsulating ensembles against airborne contamination from low dose nuclear debris radioactive fallout, bacteriological and viral airborne contamination and airborne chemical agents. Barrier suits 10 in accordance with the invention are particularly suitable for use in situations where the wearer will not be in direct contact with a source of intense contamination but will be in contact with diffused airborne contamination which still poses a valid threat to life or health over a short period of time if no form of protection was worn. This might include, for example, workers in a financial district which may become the target of a so called “dirty bomb”. Use of barrier suits 10 in accordance with the invention would enable a controlled evacuation, allowing time for organisations to implement their emergency procedures.

A further example of how the barrier suits 10 can be utilised will be when carried in police patrol vehicles, where officers can don these barrier suits to examine more closely the extent of damage of commercial tankers, and vehicles, involved in road accidents so they can access if more specific assistance will be required.

As noted previously, suits 10 in accordance with the invention may also be advantageous for use in a professional capacity where operators need to be completely enclosed so that no contaminants can enter the suit and/or so that the wearer of the suit will not contaminate their working environment.

The foregoing embodiment is not intended to limit the scope of protection afforded by the claims, but rather to describe an example as to how the invention may be put into practice.

1-35. (canceled)

36. A barrier suit comprising one-piece suit for fully encapsulating a user, the suit having a main body portion for fully encapsulating a user's torso, arms, hands, legs and feet and a hood integral with the main body portion for positioning over and encapsulating user's head, the hood including an integral filter respirator through which external air can be drawn into the suit for breathing and which comprises a moulded body for positioning over a user's nose and mouth, the body have sealing portions for sealing engagement with the user's face.

37. A barrier suit as claimed in claim 36, in which the suit is made from materials which are non-permeable to particulates and vaporous gases.

38. A barrier suit as claimed in claim 36, in which the hood is transparent.

39. A barrier suit as claimed in claim 36, in which the hood has an integral transparent visor portion.

40. A barrier suit as claimed in claim 36, in which the main body portion comprises arm portions with integral hand enclosing portions and leg portions with integral foot enclosing portions.

41. A barrier suit as claimed in claim 36, in which the respirator comprises an integrated strap arrangement, the strap arrangement being adjustable to secure the respirator over a user's mouth and nose and in which the respirator includes an exhalation outlet valve through which exhaled air may be expelled.

42. A barrier suit as claimed in claim 41, in which the exhalation valve comprises inlet fluid passage arrangement through which fluid can be administered to a user from an external source and a closure arrangement for selectively opening and closing the inlet fluid passage arrangement.

43. A barrier suit as claimed in claim 36, in which the suit comprises an adjustable integral waist strap arrangement or belt made from a flexible material.

44. A barrier suit as claimed in claim 36, in which the main body portion of the suit comprises one or more filter panels through which air can be admitted into or expelled from the suit.

45. A barrier suit as claimed in claim 44, in which at least one filter panel is located in a lower back region of the main body portion, and/or at least one filter panel is provided in a foot enclosing portion, and/or at least one filter panel is provided in a side wall region of a foot enclosing portion, and/or in which a filter panel is provided on each side of a foot enclosing portion, and/or in which the, or each, filter panel comprises activated carbon woven fibres laminated onto a fine particulate filter felt.

46. A barrier suit as claimed in claim 40, in which an external surface of the sole region of each foot enclosing portion is coated with anti-slip material and/or provided with anti-slip formations, and/or in which a sole region of each foot enclosing portion is reinforced with additional material to resist puncture, and/or in which each foot enclosing portion is provided with an inner sole member, and/or in which each foot enclosing portion is provided with an integral adjustable mechanism to maintain a secure and comfortable fit to the wearer, and in which the adjustable mechanism comprises one or more adjustable straps.

47. A barrier suit as claimed in claim 35, in which the filter respirator comprises a filter comprising activated carbon woven fibres laminated onto a fine particulate filter felt.

48. A barrier suit as claimed in claim 35, in which the main fabric of the suit comprises a non-woven and non-breathable barrier laminated to a woven fabric, in which the non-breathable barrier is selected from any one or more of the following: Polyurethane (PU), Polyvinyl Chloride (PVC), Polyethylene (PE), Ethylene Vinyl Acetate (EVA), or the like, and/or in which the woven fabric is selected from any one or more of the following: Polyester derivates including Polyester Cotton (PC), Nylon and its derivatives, cotton, rayon, and linen or the like, or in which the main fabric of the suit comprises only a non-woven, non-breathable barrier material such as PVC, PU, PE, EVA, or the like.

49. A barrier suit as claimed in claim 35, in which any seams are sealed and non-permeable, the seals being formed for example by ultrasonic welding or tape welded.

50. A barrier suit as claimed in claim 35, in which the suit has an entry opening which is closed by means of an air tight sliding fastener and in which the sliding fastener comprises a first continuously extruded elongated strip attached to the suit fabric along one side of the opening, a second continuously extruded elongate strip attached to the suit fabric along the other side of the opening, the first strip having a male projection and the second strip having a corresponding groove to receive the projection to form an air tight seal, the fastener having a slider which can be moved longitudinally of the fastener in one direction to force the male projection into the groove to close the fastener and in the opposite direction to separate the male projection from the groove to open the fastener.

51. A barrier suit as claimed in claim 50, in which a seal member is provided internally of the first and second strips at an end of the fastener at which the slider is positioned when the fastener is fully closed, the seal member being configured to seal any gaps between the first and second strips and the slider.

52. A barrier suit as claimed in claim 50, in which a curtain of activated carbon material is positioned at each end of the fastener to prevent, or at least resist, the ingress of contamination should the wearer inadvertently not close up the fastener completely.

53. A barrier suit as claimed in claim 36, in which the suit is dimensioned so that it can be worn by a majority of the able bodied, adult population.

54. A barrier suit as claimed in claim 53, in which the suit is dimensioned so that it can be worn by up to 80%, more preferably 90%, and most preferably 98%, of the able bodied, adult population.

55. A barrier suit as claimed in claim 36, when packaged in a vacuum packed bag.
